(19) United States
(12) Patent Application Publication
(10) Pub. No.: US 2020/0202414 A1
(43) Pub. Date: Jun. 25, 2020

(54) Systems and Methods for Fulfillment of an Order for a Product

(71) Applicant: BittBoard, Inc., Chicago, IL (US)

(72) Inventors: Jimmy J. Odom, Homewood, IL (US); Oluwamide M. Agunloye, Chicago, IL (US)

(73) Assignee: BittBoard, Inc., Chicago, IL (US)

(21) Appl. No.: 16/294,056

(22) Filed: Mar. 6, 2019

Related U.S. Application Data
(60) Provisional application No. 62/784,418, filed on Dec. 22, 2018.

(51) Int. Cl. G06Q 30/06; G06F 21/62; G06Q 20/14; G06Q 20/42

(52) U.S. Cl. CPC G06Q 30/0637; G06F 21/6245; G06K 7/1417; G06Q 20/42; G06Q 20/14

(57) ABSTRACT

Systems, methods, and storage media implemented by a computer system for authorizing fulfillment of an order for a product are disclosed. Exemplary implementations may include capturing, at one or more input devices coupled to one or more processors, an indicia, wherein the indicia includes at least one product indicator; decoding, at the one or more processors, the product indicator, wherein the decoded product indicator includes data indicative of a set of characteristics for the product; assembling, at the one or more processors, a purchase order based on a product id and product quantity that corresponds to the decoded product indicator, and a set of user characteristics; encrypting, at the one or more processors, the set of user characteristics; and authorizing, at the one or more processors, payment of an invoice corresponding to the purchase order.

### CROSS-REFERENCE TO RELATED APPLICATION

The present application claims the benefit of priority of U.S. Provisional Application No. 62/784,418 entitled “Systems and Methods for Fulfillment of an Order for a Product,” filed on Dec. 22, 2018, which application is further incorporated herein in its entirety.

### FIELD OF THE DISCLOSURE

The present disclosure relates to systems, methods, and storage media implemented by a computer system for fulfillment of an order for a product.

### BACKGROUND

Online commerce (ecommerce) has blossomed over the past decade. Web based vendors, such as Amazon.com, have provided convenient and reliable mechanisms for ecommerce purchase of a wide variety of consumer products. The use of mobile devices has allowed consumers to make ecommerce purchases at virtually any location and time.

However, physical commerce still outpaces ecommerce. One possible reason for this is a disconnect between most advertising and physical examples of goods and the various mechanisms for online ordering. For example, if a potential customer sees an advertisement, review of a product in a magazine, or a billboard the user must then query a shopping site or app on their computing device to find and purchase the product. Furthermore, a purchase requires that the user have a predefined account with the vendor or enter user information and payment information at the time of purchase. As a result, brands must be associated with multiple online sales channels yet their primary touchpoints with potential customers, such as advertisements and brochures, are still not integrated with the point of sale. Additionally, potential customers must, one way or another, share their personal data and payment data with each vendor. It is possible that this limits the number of vendors with which most users will interact.

Companies and individuals place computer readable indicia, such as a bar code or a QR code on a good in a manner that brings brands “closer” to purchasers. For example, a magazine ad may have indicia that can be scanned by a reader's mobile device to thereby take the reader to a website associated with the brand. In some cases, a website allows a user to purchase the product in the ad. However, the user must have an account with the website or otherwise provide the website with user personal and payment information.

### SUMMARY

One aspect of the present disclosure relates to a computer-implemented method for fulfillment of an order for a product. The method may include one or more hardware processors configured by machine-readable instructions. The method may include capturing, at one or more input devices coupled to one or more processors, an indicia, wherein the indicia includes at least one product indicator; decoding, at the one or more processors, the product indicator, wherein the decoded product indicator includes data indicative of a set of characteristics for the product; assembling, at the one or more processors, a purchase order based on a product id and product quantity that corresponds to the decoded product indicator, and a set of user characteristics; encrypting, at the one or more processors, the set of user characteristics; and authorizing, at the one or more processors, payment of an invoice corresponding to the purchase order. In some embodiments, the method disclosed above may include machine-readable instructions that cause the processors to perform additional or fewer steps than those listed above.

Another aspect of the present disclosure relates to a method implemented by a computer system for authorizing fulfillment of an order for a product. The method may include receiving, at one or more input devices coupled to one or more processors, an indicia, wherein the indicia includes at least one product indicator; decoding, at the one or more processors, the product indicator, wherein the decoded product indicator includes data indicative of a set of characteristics for the product; transmitting, at the one or more processors, the decoded product indicator to a client device; receiving from the client device, at the one or more processors, an encrypted set of user characteristics and a purchase order; assembling, at the one or more processors, an invoice with the encrypted set of user characteristics and the purchase order; and transmitting, at the one or more processors, the invoice to the client device. In some embodiments, the method disclosed above may include machine-readable instructions that cause the processors to perform additional or fewer steps than those listed above.

Yet another aspect of the present disclosure relates to a computer system including a non-transient computer-readable storage medium having instructions embodied thereon, the instructions being executable by one or more processors to perform a method implemented by a computer system for authorizing fulfillment of an order for a product. A computer system for authorizing fulfillment of an order for a product is disclosed. The system may comprise a client device; at least one server; at least one indicia; at least one vendor; and at least one storage device, wherein the at least one storage device stores computer readable instructions configured to cause the system to: capture the at least one indicia via the at least one client device; decode the indicia at the at least one server; transmit the decoded indicia to the at least one client device; assemble a purchase order based on the decoded indicia at least one server; assemble an invoice based on the purchase order; transmit the invoice to the at least one client device; and transmit an approved invoice to the at least one vendor. In some embodiments, the system disclosed above may perform additional or fewer steps than those listed above.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram of an order fulfillment system.

FIG. 2 is a block diagram of a client device for fulfillment of an order for a product, in accordance with one or more implementations.

FIG. 3 is a block diagram of a server for fulfillment of an order for a product, in accordance with one or more implementations

FIG. 4 is a block diagram of a server for fulfillment of an order for a product, in accordance with one or more implementations

FIG. 5 is a block diagram of a product database in accordance with one or more implementations.

FIG. 6 is a flow chart of a method implemented by a computer system for authorizing fulfillment of an order for a product, in accordance with one or more implementations.

### DETAILED DESCRIPTION

The methods and systems disclosed herein allow an individual to visually purchase products/services, in a secure and seamless manner, that they interact with in the physical or digital world. The users need not establish accounts with each vendor prior to purchasing their desired items. This allows users to avoid the additional hassle of registering at multiple vendors, and managing the account information for those registrations, which also creates additional security risk for users when they disclose their personal information to multiple parties.

Put another way, the implementations disclosed herein can effectively turn any target into a direct point of sale (POS). As discussed herein, products and services may be interchangeable. In the embodiments herein, products and services may be targets that a user sees, or more generally interacts with, in their environment. Targets can include an indicia that allow users to interact with them. The indicia may be an image on tangible media, such as a magazine, billboard, computer screen or virtual reality/augmented reality (VR/AR) headset. The image can be a QR code, a picture of a product, or the product itself.

Targets and/or indicias can also include geolocation features, such as detecting a user at a specified location, and/or the occurrence of any event. For example, a user can be detected, through GPS, as being at a sporting event. If it rains, the identified product could be an umbrella. This allows brands to directly monetize their advertising and other media by selling products directly from the media and/or under specific circumstances.

As another example, a user can scan a magazine ad or a billboard with a mobile device and automatically order the product indicated by the media. The implementations disclosed herein leverage the value transfer and information security of cryptocurrencies to protect the user data and the transaction data.

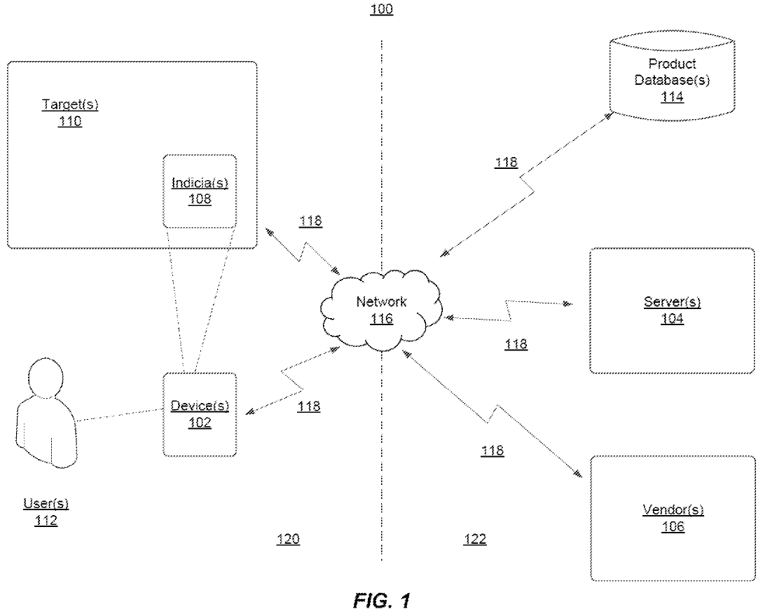

FIG. 1 illustrates an example embodiment of a system 100 for authorizing fulfillment of an order for a product. The system 100 may include additional or different components not shown in the figure. FIG. 1 includes one or more devices 102, servers 104, vendors 106, and indicia 108. In some embodiments, the system includes targets 110 that are associated with the indicia 108, as well as users 112 that may be using the devices 102, and one or more product databases 114. As described herein, the devices 102 may be referred to as client computing platforms. The devices 102, servers 104, vendors 106, indicia 108/target 110, and product database 114 may all be communicatively coupled together through a network 116, such as the Internet, via network connections 118. The system may be conceptually divided into an environment 120 where the user 112 ultimately wishes to purchase something, and a backend purchase processing environment 122 where coordinating with vendors 106 via the one or more servers 104 takes place.

In some embodiments, the servers 104 may include the product databases 114 that may store product identification information and product metadata in the manner described below in detail. Additional embodiments may include an ad network that can be coupled to the system to serve ads based on user activity and product metadata in a known manner. Users 112 may use devices 102 in communication with the servers 104 to purchase products they interact with in their environment. Vendors 106 may process orders for products. Payments from users 112 to vendors 106 can be made over one or more payment networks, such as a cryptocurrency payment network.

In some embodiments, the vendors 106 may utilize an indicia generation program via the server 104. The vendor 106 may then upload relevant product info and images of products to the server 104 for the generation of the indicia 108. This product info and corresponding images may be stored in the product database 114.

Once generated the vendor 106 is able to deploy the indicia 108 on advertisements that they have in the physical or digital world. Through this process the indicia 108 are prepared by the vendor 106 for the user 112 to experience a more seamless purchasing experience by not having to manually input product information associated with an image of a product they wish to purchase. In this manner each vendor 106 may join an advertising network that is setup to allow users 112 to visually purchase the products listed in the advertising network.

An example scenario of the purchasing process enabled by the system 100 of FIG. 1 may be as follows. A user 112 may be walking along a street and see a billboard for a pair of athletic shoes that they want to purchase. The athletic shoes may be considered a target 110. The user 112 may hold up their device 102, which in this example may be a mobile phone, and point it at the billboard. The device 102 may capture the indicia 108, and by capturing the indicia with their device 102 the purchasing process begins. Accordingly, the device 102 communicates with the servers 104 to generate a secure invoice for the purchasing of the athletic shoes. Once the invoice is constructed by the servers in conjunction with the device 102 the user 112 approves the purchase and only the necessary information to fulfill the order is sent to the vendor 106. Additionally, the user 112 may wish to purchase the item with cryptocurrency, but the vendor 106 may only wish to receive payment in fiat currency. The conversion between cryptocurrency and fiat, and the handling of the cryptocurrency payment may be handled by the device 102, the servers 104, or by both devices and servers prior to payment being sent to the vendor 106.

Similar purchasing scenarios may occur in digital environments as well as physical environments. For example, a user 112 may see a digital item in a virtual world that they wish to purchase. In this scenario, a virtual reality headset may be considered the device 102. A similar process as described with respect to purchasing the athletic shoes above may be followed to effectuate the purchase of the digital item.

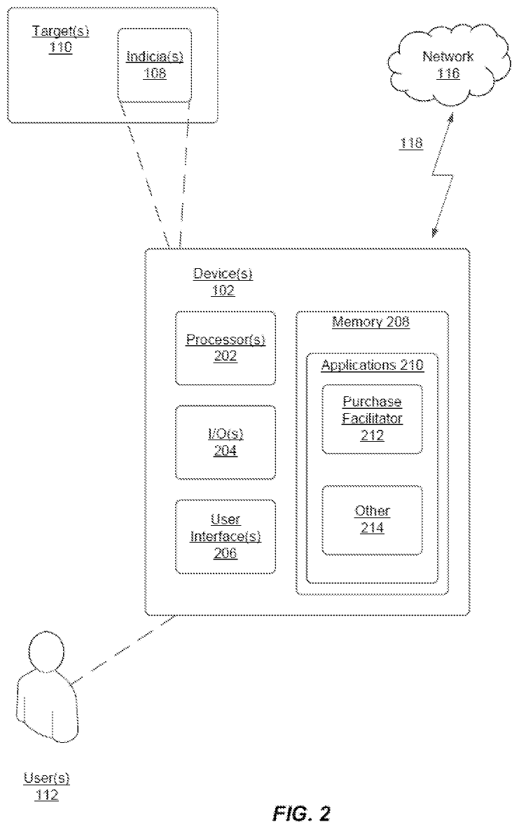

FIG. 2 illustrates an example embodiment of a device 102. FIG. 2 shows a user 112 using the device 102, the target 110 with indicia 108, as well as the device 102 connected to the network 116 via the networks connections 118. The device 102 may include one or more processors 202, input/output components 204, one or more user interfaces 206, and one or more memories 208. Stored in memory 208 may be one or more applications 210, such as a purchase facilitator 212 and other applications 214 necessary for the user to interact with the device 102. In some embodiments, the applications listed above may be modules or components that are a part of one individual application.

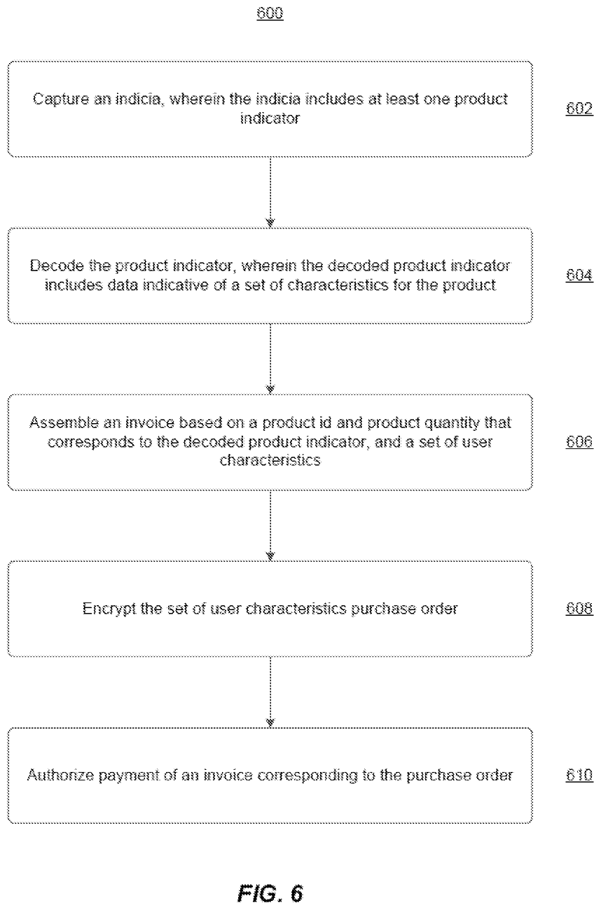

The payment facilitator 212 may be the main application that the user 112 utilizes to purchase items they see and interact with as described above. Example operations of the purchase facilitator 212 application are described herein, and in particular with respect to FIG. 6 below. In some embodiments, the purchase facilitator 212 may include functionality to manage a cryptocurrency wallet on behalf of the user 112. Similarly, the purchase facilitator may also include functionality to manage the creation, encryption, and deletion of metadata about the user 112 and their purchases. The purchase facilitator 212 may also

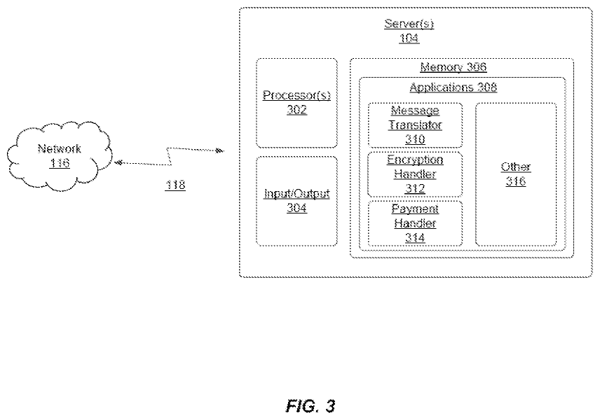

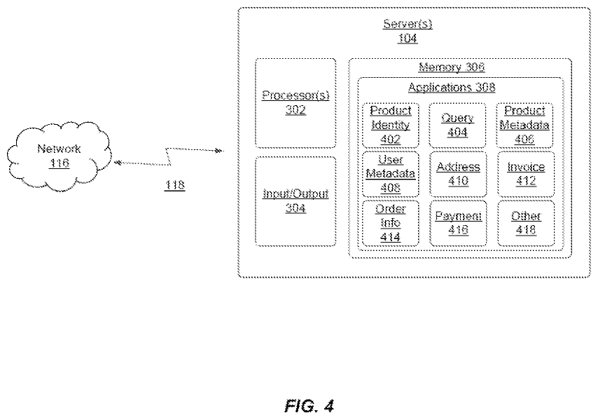

In the purchasing scenarios described above, the user 112 may use the device 102 to capture the indicia 108 on the target 110. In particular, one or more input/output components 204, such as a camera, may be used to capture the indicia 108. The processors 202, in conjunction with the memory 208, may execute computer readable instructions on behalf of the purchase facilitator application 212 to complete purchases on behalf of the user 112. The entire purchasing process may be managed by the user through the user interfaces 206, which may include keyboards, touch pads, touch screens, other haptic devices, as well as user input translators for virtual reality headsets. As part of the purchase process the device 102 may interact with one or more servers, such as server 104 depicted in FIG. 1 that are further explained with respect to FIGS. 3 and 4.

FIG. 3 illustrates an example embodiment of one or more server(s) 104 for authorizing fulfillment of an order for a product, in accordance with one or more implementations disclosed herein. The servers 104 may be connected a network 116 via the one or more network connections 118. Server(s) 104 may be configured to communicate with one or more client computing platforms 102 according to a client/server architecture and/or other architectures, such as the device depicted in FIGS. 1 and 2. Users, such as the users described in FIG. 1, may access the server 104 via client computing platform(s) 102.

Server(s) 104 may include processor(s) 302, input/output components 304, and memory 306. Stored within the memory 306 may be applications configured to execute particular instructions, work flows, and processes in furtherance of facilitating the purchase of a good or service for the benefit of a user.

The applications 308 may be configured to interact with the processors 302 and input/output components 304 to execute the particular instructions, work flows, and processes contained within each application stored in memory. The applications 308 may be executed by machine-readable instructions. The applications 308 may include one or more of a message translator application 310, an encryption handler application 312, a payment handler application 314, and/or other applications 316. In some embodiments, the applications listed above may be modules or components that are a part of one individual application.

In some embodiments, the message translator application 310 may have functionality that allows it to receive product information from a device 102 and decode that information. By decoding the information the message translator 310 may determine whether or not the product information is relevant to the whitelist of previously stored products for sale by vendors 106. This whitelist, as described herein, may be stored at the product database 114 of FIG. 1, or in some embodiments at other locations at the server 104, or elsewhere.

In some embodiments, the encryption handler application 312 may have functionality that allows it to encrypt and decrypt data relevant to the purchase process. In particular, invoices generated by the server 104 may be encrypted.

In some embodiments, the payment handler application 314 may have functionality that allows the server 104 to coordinate the purchase process for the device 102 and the vendor 106. In particular, the payment handler 314 may manage the conversion from cryptocurrency to fiat currency on behalf of the vendor 106.

FIG. 4 is an alternative embodiment of one or more server(s) 104 for authorizing fulfillment of an order for a product, in accordance with one or more implementations disclosed herein. The servers 104 may be connected a network 116 via the one or more network connections 118. Server(s) 104 may be configured to communicate with one or more client computing platforms 102 according to a client/server architecture and/or other architectures, such as the device depicted in FIGS. 1 and 2. Users, such as the users described in FIG. 1, may access the server 104 via client computing platform(s) 102.

Server(s) 104 may include processor(s) 302, input/output components 304, and memory 306. Stored within the memory 306 may be applications configured to execute particular instructions, work flows, and processes in furtherance of facilitating the purchase of a good or service for the benefit of a user.

The applications 308 may be configured to interact with the processors 302 and input/output components 304 to execute the particular instructions, work flows, and processes contained within each application stored in memory. The applications 308 may be executed by machine-readable instructions. The applications 308 may include one or more of a product identity application 402, a query application 404, a product metadata application 406, a user metadata application 408, an address application 410, an invoice application 412, an order information application 414, a payment application 416, and/or other applications 418. In some embodiments, the applications listed above may be modules or components that are a part of one individual application.

Product identity application 402 may be configured to receive product identity information from a client device (client computing platform 102) associated with a user. The product identity information may be derived from a target, such as the indicia 108 of FIG. 1, or target 110. The target may be a product or service that a user is interested in purchasing, or a QR code and the product identity information can be derived from the QR code by a decoding application executing on the client device. The target may be a picture of the specific product or another image describing the specific product that can be resolved to a specific product. Further, the target can be a product, a logo, or other descriptive text or the like that can be associated with the product. The target can also be the product itself, on a store shelf or on another person “in the wild”, for example. The target can be a billboard, an advertisement in a magazine, a display on a computing device, the physical product itself, or any other target. The target may also be a VR/AR image or event, or real-world events or location detection.

Query application 404 may be configured to send a query to product database 114. The query may be based on the product identity information. A product metadata receiving module may be configured to receive from product database 114, in response to the query, product metadata describing attributes of a specific product corresponding to the product identity information and a generic invoice (described below) corresponding to the specific product. The generic invoice can include an identification of the product and other information common to all orders for the product and/or a vendor assigned to the product.

Alternatively, the database need not store generic invoices and invoices can be created entirely “on-the fly”, as described below. Product database 114 can be configured to store all of the information described above, including product metadata describing attributes of products, identity data for one or more vendors corresponding to each product, product identifying data and generic product invoices, all in a retrievable structure such as a relational database. Product database 114 is described in greater detail below.

Product metadata application 406 may be configured to send at least some of the received product metadata to the client device. The product metadata may be formatted in a manner that can be displayed on a user interface of the client device. The product metadata can include a description of the product, user reviews, color and style choices, availability and other information describing the product and availability of the product. User metadata data application 408 may be configured to receive, from the client device, user metadata data. Alternatively, user metadata can be sent directly to the appropriate vendor. The user metadata may be encrypted to prevent the server(s) 104, or other participants in the system such as vendors 106, from using the user metadata in any manner other than for the intended purpose. The user metadata can include the user's name, shipping address, payment information, and user preferences.

Address application 410 may be configured to receive an address of a user cryptographic wallet corresponding to the user on a cryptographic payment network that may interface with the components depicted in FIG. 1. The address application 410 may receive an address of a user cryptographic wallet that already exists, or may create the user cryptographic wallet on the cryptographic payment network on behalf of the user. The cryptographic payment network may be a payment channel on the Lightning Network or any other cryptographic payment channel such as the Bitcoin blockchain. The address application 410 may be configured to insert a payer address (user wallet address) and the user metadata into the generic invoice to create an order-specific invoice or create the entire order-specific invoice at this point. The order-specific invoice can be a Lightning Network invoice as described in greater detail below, or an appropriate “invoice” for any other payment channel.

When a user purchases a good or service using a method or system disclosed herein, an invoice may be generated. Invoice application 412 may be configured to send the order-specific invoice to the user. Order information application 414 may be configured to send order information to a vendor corresponding to the specific product for fulfillment of the order. As noted above, user data can be sent directly from the user to the vendor.

Payment application 416 may be configured to receive, from a user cryptographic wallet, payment of cryptocurrency from the user cryptographic wallet corresponding to the order-specific invoice. The payment application 416 may be configured to authorize payment in a fiat currency in response to the received payment of cryptocurrency. The payment application 416 may be configured to, in response to receiving payment from the user cryptographic wallet, interface with a user's bank, or other financial institution where the user hold's fiat currency, to authorize payment in a fiat currency to vendor 110 for processing of the order. The payment transaction of cryptocurrency may be recorded on a blockchain.

If any user data has been sent to the system, user metadata application 408 may be configured to delete all user metadata from the computer system. Again, as noted above, encrypted user metadata can be sent directly from the user to the vendor who can decrypt the user metadata and use it to fulfill the order.

In some implementations, the user metadata may be encrypted, and the order-specific address is sent over a secure communication channel, such as a known Level 3 payment channel which includes specific data that protects a buyer from unauthorized use of payment information. Level 3 security is well known and is described at the following website: https://blog.bluepay.com/what-is-level-3-payment-processing.

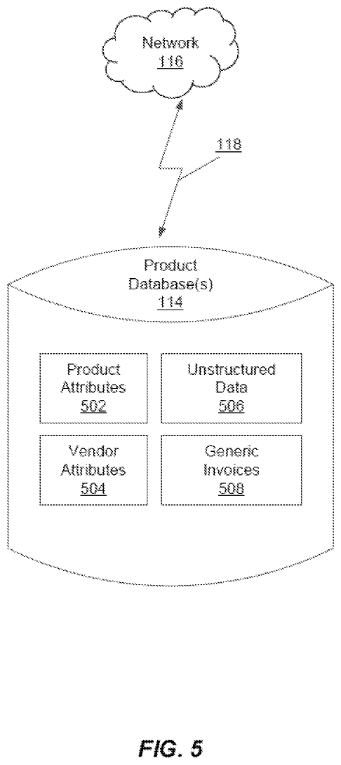

An example implementation of product database 114 is illustrated in greater detail in FIG. 5. The product database 114 may be connected to a network 116 via network connections 118. The product database can be in the form of a relational database (MySQL for example) and includes product attributes table 502, vendor attributes table 504, and unstructured data 506. Product attributes table 502 can include product information in the form of a catalog of products organized into categories with corresponding attributes describing characteristics of the products and corresponding values for the attributes. Vendor Attributes table 504 can include vendor information and can associate one or more vendors with one or more products in the catalog. Unstructured data 406 can include product images and other indicia, such as pictures, QR codes or bar codes associated with one or more products, VR/AR images, locations, events and the like, to associate products with targets. Product Database 114 also includes generic invoices 408 which are described in greater detail below. The various data can be in the form of tables that are related to one another as a single relational database. In some cases, the individual tables are referred to as a “database” herein.

The following described methods and systems may be executed by the device 102 and server 104 of FIG. 1 working in conjunction, as well as by the device 102 of FIG. 2, and the servers of FIGS. 3 and 4.

FIG. 6 is an example method 600 for fulfilling purchase of a product. The disclosed method 600 may include additional, or fewer, steps than those that are depicted in FIG. 6. The method may be executed by the device 102 discussed herein, such as, for example, by the device 102 disclosed in FIG. 2.

In one embodiment, the method 600 for authorizing fulfillment of an order for a product, may comprise: capturing, at one or more input devices coupled to one or more processors, an indicia, wherein the indicia includes at least one product indicator (block 602); decoding, at the one or more processors, the product indicator, wherein the decoded product indicator includes data indicative of a set of characteristics for the product (block 604); assembling, at the one or more processors, a purchase order based on a product id and product quantity that corresponds to the decoded product indicator, and a set of user characteristics (block 606); encrypting, at the one or more processors, the set of user characteristics (block 608); and authorizing, at the one or more processors, payment of an invoice corresponding to the purchase order (block 610).

In some embodiments of the method 600 the one or more input devices may be a camera controllable by a user of a mobile device, an AR wearable, a VR wearable, or some combination thereof. In some cases, the AR wearable or VR wearable may be a headset, in other situations the wearable may be a different type of electronic device worn on a person. Similarly, in other embodiments the one or more input devices may be any of the different types of devices 102 described herein.

In some embodiments of the method 600, the indicia may be a QR code, a product image, an advertisement or ad campaign, an audio cue, a visual pattern, or some combination thereof. For example, an indicia may be placed at a sign at an entertainment venue (as discussed above), an indicia in an online multiplayer game, or some other point of interest for the user. The indicia may take the form of any sort of stimulus that the user 112 may interact with.

In some embodiments of the method 600 decoding may include transmitting, at the one or more processors coupled to one or more network interfaces, the indicia to one or more servers; and receiving, at the one or more processors coupled to one or more network interfaces, the product indicator if it has been matched with a whitelist of products.

In some embodiments of the method 600 the set of user characteristics comprises a user address, user identification information, and other user preferences. These user characteristics may need to be protected to protect the user's anonymity and their purchasing history. Accordingly, in some embodiments of the method 600 encrypting the set of user characteristics further comprises: transmitting, at the one or more processors coupled to one or more network interfaces, the encrypted set of user characteristics and the purchase order to one or more servers.

In some embodiments of the method 600 authorizing the invoice further comprises: processing, at the one or more processors, a set of user inputs that indicate a user's verification of the purchase details. The set of user inputs may be received after the user is prompted via a user interface to confirm their purchase details. The user may confirm the purchase details, confirm the delivery information for the purchase, and confirm that they wish to pay for the purchase. In some embodiments, the user may be confirming to pay using the Lightning Network.

An alternative embodiment of the method above is disclosed as follows. The method may include receiving product identity information from a client device associated with a user. The product identity information may be derived from a target. For example, the user device may have taken a picture of a magazine ad or a billboard containing a QR code associated with a product and an application on the user device may have decoded to the QR code and sent the data to the server. Other targets are described above.

The alternative embodiment may further include the server sending a query for product metadata to a product database. The query may be based on the product identity information. For example, the server may request descriptive information, quantity information, price information and delivery/availability information from product database.

The alternative embodiment may further include the server receiving, in response to the query, product metadata describing attributes of a specific product corresponding to the product identity information, delivery and pricing information for a vendor associated with the product, and a generic invoice corresponding to the product.

The alternative embodiment may further include sending the product metadata to the client device. The product metadata may be formatted in a manner that can be displayed on a user interface of the client device. For example, a description of the product, a price of the product and availability of the product may be displayed on the user device. Also, one or more user interface elements may be displayed on the user device to allow the user to, for example, select a quantity, color, and delivery option for the product and to request an order.

The alternative embodiment may further include the server receiving, from the client device, user metadata, such as the user delivery address. As noted above, the user metadata could also be sent directly from the user to the vendor. The user metadata can be encrypted and sent over a secure channel. The user metadata can comply with a Level 3 transaction.

The alternative embodiment may further include the receiver receiving, from the user device, an address of a user cryptographic wallet corresponding to the user on a cryptographic payment Network. The payment network can be, for example, the Lightning network whose characteristics and operations are described in more detail below.

The alternative embodiment may further include creating an order-specific invoice for transmission to the user. Similarly, the alternative embodiment may include sending the order-specific invoice to the user for processing a cryptocurrency payment in known manner. For example, a Lightning Network invoice can be sent for processing on the Lightning Network. Creation of the order-specific invoice is discussed in more detail below. The alternative embodiment may further include the server sending order information to a vendor corresponding to the specific product for fulfillment of the order.

The alternative embodiment may further include receiving, payment, over the payment network, of cryptocurrency from the user cryptographic wallet corresponding to the invoice. The payment may be received in one or cryptographic wallets corresponding to the server or the operator of the server.

The alternative embodiment may further include in response to receiving payment from the user cryptographic wallet, the server authorizing payment in a fiat currency to the vendor for fulfillment of the order. Payment can be authorized for payment over conventional banking networks using the SWIFT messaging protocol.

A computer-implemented method for authorizing fulfillment of an order for a product is disclosed. The method may be executed by one or more servers, such as the server 104 of FIG. 1, or the servers depicted in FIGS. 3 and 4. The method comprises receiving, at one or more input devices coupled to one or more processors, an indicia, wherein the indicia includes at least one product indicator; decoding, at the one or more processors, the product indicator, wherein the decoded product indicator includes data indicative of a set of characteristics for the product; transmitting, at the one or more processors, the decoded product indicator to a client device; receiving from the client device, at the one or more processors, an encrypted set of user characteristics and a purchase order; assembling, at the one or more processors, an invoice with the encrypted set of user characteristics and the purchase order; and transmitting, at the one or more processors, the invoice to the client device.

In some embodiments of the method, the indicia may be a QR code, a product image, an audio cue, a visual pattern, or some combination thereof.

In some embodiments of the method, decoding further comprises validating, at the one or more processors, the indicia against a whitelist of products. Additionally, in some embodiments, validating the indicia against a whitelist of products further comprises: checking, at the one or more processors, for the existence of the product indicator in the whitelist of products.

In some embodiments of the method, assembling the invoice further comprises: encrypting, at the one or more processors, the invoice. The encryption may be performed according to the encryption methods discussed herein.

Some embodiments of the method further comprise receiving, at the one or more processors, an approved invoice; and transmitting, at the one or more processors, the approved invoice to a vendor for fulfillment of the order for the product.

A computer system for authorizing fulfillment of an order for a product is disclosed. The system may comprise a client device; at least one server; at least one indicia; at least one vendor; and at least one storage device, wherein the at least one storage device stores computer readable instructions configured to cause the system to: capture the at least one indicia via the at least one client device; decode the indicia at the at least one server; transmit the decoded indicia to the at least one client device; assemble a purchase order based on the decoded indicia at least one server; assemble an invoice based on the purchase order; transmit the invoice to the at least one client device; and transmit an approved invoice to the at least one vendor.

In some embodiments of the system the indicia may be a QR code, a product image, an audio cue, a visual pattern, or some combination thereof.

In some embodiments of the system decode the indicia further comprises computer readable instructions to cause the system to: validate the indicia against a whitelist of products.

In some embodiments of the system assemble a purchase order further comprises computer readable instructions to cause the system to: encrypt a set of user characteristics. Similarly, the set of user characteristics comprises a user address, user identification information, and other user preferences.

In some embodiments of the system transmit the invoice to the at least one client device further comprises computer readable instructions to cause the system to: prompt a user of the at least one client device to approve the information in the invoice.

The methods discussed herein may be implemented via in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

The server(s) 104, client computing platform(s) 102, and/or vendors 106 may be communicatively linked via one or more electronic communication links 118. For example, such electronic communication links may be established, at least in part, via a network such as the Internet and/or other networks. It will be appreciated that this is not intended to be limiting, and that the scope of this disclosure includes implementations in which server(s) 104, client computing platform(s) 102, and/or vendors 106 may be operatively linked via some other communication media.

A given client computing platform 102 may include one or more processors configured to execute computer program modules. The computer program modules may be configured to enable a user associated with the given client computing platform 102 to interface with system 100 and/or provide other functionality attributed herein to client computing platform(s) 102. By way of non-limiting example, the given client computing platform 102 may include one or more of a desktop computer, a laptop computer, a handheld computer, a tablet computing platform, a Smartphone, a gaming console, a VR/AR headset or other device, and/or other computing platforms.

Server(s) 104 may include electronic storage and one or more processors, and/or other components. Server(s) 104 may include communication lines, or ports to enable the exchange of information with a Network and/or other computing platforms. Illustration of server(s) 104 is not intended to be limiting. Server(s) 104 may include a plurality of hardware, software, and/or firmware components operating together to provide the functionality attributed herein to server(s) 104. For example, server(s) 104 may be implemented by a cloud of computing platforms operating together as server(s) 104.

The electronic storage may comprise non-transitory storage media that electronically stores information. The electronic storage media may include one or both of system storage that is provided integrally (i.e., substantially non-removable) with server(s) 104 and/or removable storage that is removably connectable to server(s) 104 via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private Network, and/or other virtual storage resources). The electronic storage may store software algorithms, information determined by processor(s), information received from server(s) 102, information received from client computing platform(s) 102, Product Database 114 and/or other information that enables server(s) 104 to function as described herein.

Processor(s) may be configured to provide information processing capabilities in server(s) 104. As such, processor(s) may include one or more of a digital processor, an analog processor, a digital circuit designed to process information, an analog circuit designed to process information, a state machine, and/or other mechanisms for electronically processing information. Although processor(s) are shown in FIG. 1 as a single entity, this is for illustrative purposes only. In some implementations, processor(s) may include a plurality of processing units. These processing units may be physically located within the same device, or processor(s) may represent processing functionality of a plurality of devices operating in coordination. Processor(s) may be configured to execute instructions for applications, or modules, by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The various messaging and data transfer described above can be accomplished with a REST API (or “RESTful” API). A RESTful API is an application program interface (API) that uses HTTP calls to request resources as opposed to functions. The function is embedded in the HTTP call through requests to GET, PUT, POST and DELETE, for example. The API spells out the proper way to request data, from an operating system or other application and allows management of customer data, sales orders, inventory, and products. This entire process can be open-sourced to the general public through permissioned API endpoints and PGP keys for encryption of data transmission in a single package as an SDK.

As noted above, some implementations use a channel of the Lightning Network as a payment channel. The Lightning Network is a “second layer” payment protocol that operates on top of a blockchain, such as the Bitcoin blockchain. The protocol of the Lightning Network enables relatively fast transactions between participating nodes and thus addresses blockchain scalability issues. The Lightning Network establishes a peer-to-peer system for making micropayments of cryptocurrency through a network of bidirectional payment channels without delegating custody of funds.

A user of the Lightning Network can open a payment channel by committing a funding transaction to the relevant blockchain. Subsequently, the user can make one or more transactions with another party that update the distribution of the channel's funds without broadcasting any transactions to the blockchain. When the payment channel is closed, the final version of the transaction is sent to the blockchain to distribute the channel's funds. Lightning Network Channels can be thought of as an off-chain netting process. The payment process works by receiving an invoice from some web service and paying it with a Lightning Network Wallet. No custodian or central authority needs to be involved

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented method for authorizing fulfillment of an order for a product, the system comprising:
capturing, at one or more input devices coupled to one or more processors, an indicia, wherein the indicia includes at least one product indicator;
decoding, at the one or more processors, the product indicator, wherein the decoded product indicator includes data indicative of a set of characteristics for the product;
assembling, at the one or more processors, a purchase order based on a product id and product quantity that corresponds to the decoded product indicator, and a set of user characteristics;
encrypting, at the one or more processors, the set of user characteristics; and
authorizing, at the one or more processors, payment of an invoice corresponding to the purchase order.

2. The computer-implemented method of claim 1, wherein the one or more input devices may be a camera controllable by a user of a mobile device, an AR wearable, a VR wearable, or some combination thereof.

3. The computer-implemented method of claim 1, wherein an indicia may be a QR code, a product image, an audio cue, an advertisement, a visual pattern, or some combination thereof.

4. The computer-implemented method of claim 1, wherein decoding further comprises:
transmitting, at the one or more processors coupled to one or more network interfaces, the indicia to one or more servers; and
receiving, at the one or more processors coupled to one or more network interfaces, the product indicator if it has been matched with a whitelist of products.

5. The computer-implemented method of claim 1, wherein the set of user characteristics comprises a user address, user identification information, and other user preferences.

6. The computer-implemented method of claim 1, wherein encrypting the set of user characteristics further comprises:
transmitting, at the one or more processors coupled to one or more network interfaces, the encrypted set of user characteristics and the purchase order to one or more servers.

7. The computer-implemented method of claim 1, wherein authorizing the invoice further comprises:
processing, at the one or more processors, a set of user inputs that indicate a user's verification of the purchase details.

8. A computer-implemented method for authorizing fulfillment of an order for a product, the system comprising:
receiving, at one or more input devices coupled to one or more processors, an indicia, wherein the indicia includes at least one product indicator;
decoding, at the one or more processors, the product indicator, wherein the decoded product indicator includes data indicative of a set of characteristics for the product;
transmitting, at the one or more processors, the decoded product indicator to a client device;
receiving from the client device, at the one or more processors, an encrypted set of user characteristics and a purchase order;
assembling, at the one or more processors, an invoice with the encrypted set of user characteristics and the purchase order; and
transmitting, at the one or more processors, the invoice to the client device.

9. The computer-implemented method of claim 8, wherein the indicia may be a QR code, a product image, an audio cue, a visual pattern, or some combination thereof.

10. The computer-implemented method of claim 8, wherein the indicia is received from a user of a mobile device, an AR wearable, a VR wearable, or some combination thereof.

11. The computer-implemented method of claim 8, wherein decoding further comprises:
validating, at the one or more processors, the indicia against a whitelist of products.

12. The computer-implemented method of claim 11, wherein validating the indicia against a whitelist of products further comprises:
checking, at the one or more processors, for the existence of the product indicator in the whitelist of products.

13. The computer-implemented method of claim 8, wherein assembling the invoice further comprises:
encrypting, at the one or more processors, the invoice.

14. The computer-implemented method of claim 8, further comprising:
receiving, at the one or more processors, an approved invoice; and
transmitting, at the one or more processors, the approved invoice to a vendor for fulfillment of the order for the product.

15. A computer system for authorizing fulfillment of an order for a product, the system comprising:
a client device;
at least one server;
at least one indicia;
at least one vendor; and
at least one storage device, wherein the at least one storage device stores computer readable instructions configured to cause the system to:
capture the at least one indicia via the at least one client device;
decode the indicia at the at least one server;
transmit the decoded indicia to the at least one client device;
assemble a purchase order based on the decoded indicia at least one server;
assemble an invoice based on the purchase order;
transmit the invoice to the at least one client device; and
transmit an approved invoice to the at least one vendor.

16. The computer system of claim 15, wherein the indicia may be a QR code, a product image, an audio cue, an advertisement, a visual pattern, or some combination thereof.

17. The computer system of claim 15, wherein decode the indicia further comprises computer readable instructions to cause the system to:
validate the indicia against a whitelist of products.

18. The computer system of claim 15, wherein assemble a purchase order further comprises computer readable instructions to cause the system to:
encrypt a set of user characteristics.

19. The computer system of claim 18, wherein the set of user characteristics comprises a user address, user identification information, and other user preferences.

20. The computer system of claim 15, wherein transmit the invoice to the at least one client device further comprises computer readable instructions to cause the system to:
prompt a user of the at least one client device to approve the information in the invoice.
